(19) United States
(12) Patent Application Publication
(10) Pub. No.: US 2018/0335127 A1
(43) Pub. Date: Nov. 22, 2018

(54) Pump for Torque Transfer Device

(71) Applicant: BorgWarner Inc., Auburn Hills, MI (US)

(72) Inventors: Travis J. Wentz, Oakland Township, MI (US); Blake R. Hedges, Orion, MI (US)

(73) Assignee: BorgWarner Inc., Auburn Hills, MI (US)

(21) Appl. No.: 15/597,659

(22) Filed: May 17, 2017

(51) Int. Cl. F16H 57/04; F04C 2/10; F04C 15/00; B60K 17/344; F16D 23/12; F16D 28/00; F16D 13/38; F16D 11/14

(52) U.S. Cl. CPC F16H 57/0441; F04C 2/102; F04C 15/0073; B60K 17/344; F16H 57/0436; F16D 23/12; F16D 2023/123; F16D 13/38; F16D 11/14; F04C 2220/00; F04C 2240/30; F04C 2240/20; F16D 28/00

(57) ABSTRACT

A torque transfer device for a powertrain of a vehicle includes a shaft, a pump, and an actuator. The shaft transfers torque from a drive source to a wheel of the vehicle. The pump includes a rotary component and a housing that surround the shaft. The rotary component is selectively coupleable to the shaft to be rotated thereby to operate the pump. The actuator includes a cam mechanism that selectively couples the rotary component to the shaft.

### CROSS-REFERENCE TO RELATED APPLICATION(S)

None.

### TECHNICAL FIELD

This disclosure relates to torque transfer devices for vehicle powertrains and, in particular, to pumps and torque transfer devices comprising the same.

### BACKGROUND

Vehicle powertrains may include torque transfer devices that transfer torque from an input to one or more outputs. For example, a transfer case is a type of torque transfer device that is configured to transfer torque from an input to a primary output, such as a rear output shaft, and selectively to a secondary output, such as a front output shaft. The torque transfer device may include a pump, which circulates fluid (e.g., oil), for example, to lubricate interfaces between components of the torque transfer device (e.g., rotating shafts and support bearings) and/or to cool various components. The pump may be driven by the torque transfer device being permanently operationally coupled to the rear output shaft thereof. However, when fluid is not required, the pump unnecessarily creates load (e.g., drag) on the torque transfer device, thereby reducing operational efficiency of the torque transfer device and of the vehicle powertrain.

### SUMMARY

Disclosed herein are implementations of torque transfer devices, including transfer cases and pumps therefor. In one implementation, a torque transfer device for a powertrain of a vehicle includes a shaft, a pump, and an actuator. The shaft transfers torque from a drive source to a wheel of the vehicle. The pump includes a rotary component and a housing that surround the shaft. The rotary component is selectively coupleable to the shaft to be rotated thereby to operate the pump. The actuator includes a cam mechanism that selectively couples the rotary component to the shaft.

The cam mechanism may include a motor and a cam member that is rotated by the motor for coupling the rotary component to the shaft with a friction coupling. The rotary component may include a coupling portion that protrudes axially from the housing and that surrounds the shaft. The coupling portion is selectively coupleable to an annular member of the pump to form the friction coupling. The annular member may be rotatably fixed to and axially movable relative to the shaft by the cam mechanism.

In an implementation, a pump includes a pumping portion and an actuator portion. The pumping portion includes a housing and a rotary component rotatable within the housing for pumping a fluid. The actuator portion includes a coupling portion and an annular member. The coupling portion is formed integrally with the rotary component and extends axially from the housing. The annular member is movable axially toward the coupling portion to couple the rotary component to a drive shaft for operating the pump. The housing, the rotary component, the coupling portion, and the annular member are each configured for the drive shaft to extend therethrough. The annular member is configured to be rotatably fixed to and axially movable relative to the drive shaft.

In an implementation, a transfer case includes a primary output shaft and a pump. The pump surrounds and is selectively operatively coupleable to the primary output shaft for operating the pump. The pump includes a housing, a rotary component, an annular member, and an actuator. The rotary component is partially enclosed within the housing and protrudes from the housing to form a coupling portion. The rotary component is rotatable within the housing to pump a fluid through the pump. The annular member is rotatably fixed to and axially movable relative to the primary output shaft. The actuator moves the annular member axially toward the coupling portion to operatively couple the coupling portion of the rotary component to the primary output shaft.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of a vehicle having a powertrain.

FIG. 2 is a cross-sectional view of a transfer case of the powertrain.

FIG. 3A is a detail view of a pump of the transfer case taken from box 3-3 in FIG. 2, the pump being in a first state.

FIG. 3B is a detail view of the pump of the transfer case taken from box 3-3 in FIG. 2, the pump being in a second state.

FIG. 4A is a partial cross-sectional view of the pump of FIG. 3A taken along line 4A-4A in FIG. 3A with various components omitted.

FIG. 4B is a partial cross-sectional view of the pump of FIG. 3A taken along line 4B-4B in FIG. 3A with various components omitted and hidden components depicted in dashed lines.

FIG. 4C is a partial cross-sectional view of the pump of FIG. 3A taken along line 4C-4C in FIG. 3A with various components omitted and hidden components depicted in dashed lines.

FIG. 4D is a partial cross-sectional view of the pump of FIG. 3A taken along line 4D-4D in FIG. 3A with hidden components depicted in dashed lines.

FIG. 5 is a cross-sectional view of another embodiment of a pump.

FIG. 6A is a cross-sectional view of another embodiment of a pump.

FIG. 6B is a detail view of the pump of FIG. 6A taken from box 6B-6B in FIG. 6A.

### DETAILED DESCRIPTION

Disclosed herein are embodiments of torque transfer devices (e.g., transfer cases) of vehicle powertrains, which include pumps that are selectively driven by the torque transfer device. For example, a transfer case includes a pump (e.g., gerotor pump) that generally surrounds a primary output shaft of the transfer case. The pump is selectively actuated by an actuator mechanism that operationally couples the pump to the primary output shaft. The actuator mechanism is operated by an electric motor, which may also control other functions of the transfer case (e.g., range selection).

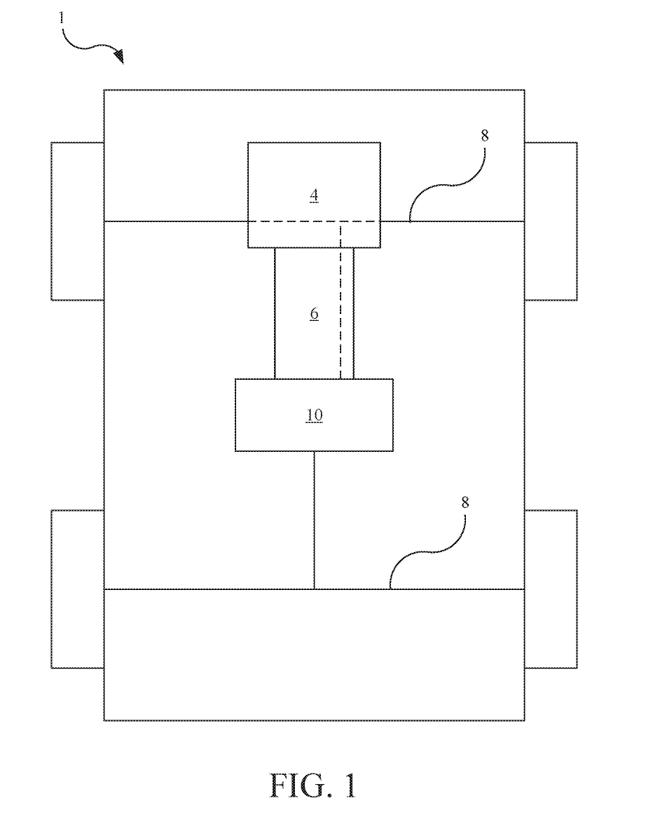

Referring to FIG. 1, a vehicle 1 includes a powertrain 2 having an engine 4 (or other drive source), a transmission 6, axles 8, and a transfer case 10. The engine 4 provides an output torque to the transmission 6, which in turn provides output torque to the transfer case 10. The transfer case 10 transfers torque from the transmission to one of the axles 8 (e.g., a rear axle) and selectively transfers torque to another of the axles 8. The axles 8 may be assemblies that include a differential and two half-shafts that each extend to a wheel (not labeled).

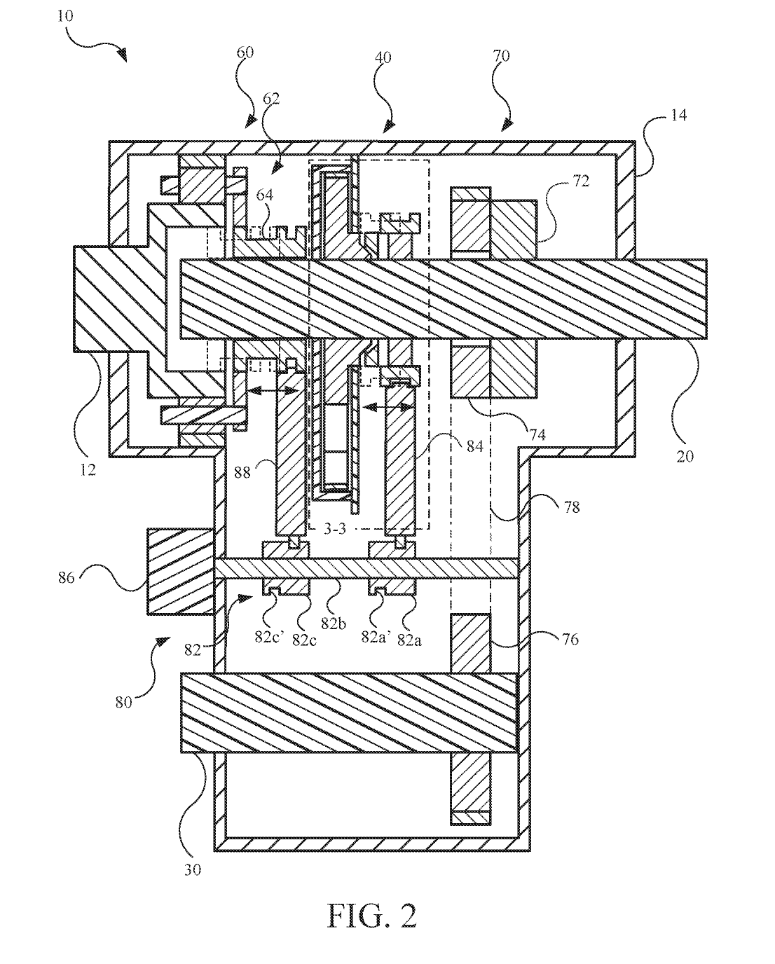

Referring to FIG. 2, a transfer case 10 generally includes an input shaft 12 (e.g., input), a primary output shaft 20 (e.g., drive shaft, or main or rear output shaft), a secondary output shaft 30 (e.g., a front output shaft), and a pump 40 (e.g., pump unit) disposed within a transfer case housing 14. Each of the primary output shaft 20 and the secondary output shaft 30 transfer torque from a drive source (i.e., the engine 4) to a wheel of the vehicle 1. As discussed in further detail below, the pump 40 is selectively operationally coupled to the primary output shaft 20 to pump a fluid (e.g., oil) for cooling and/or lubrication of various components or systems within the transfer case housing 14. The transfer case may additionally include a gear reduction mechanism 60, a secondary torque transfer mechanism 70, and an actuator 80 (e.g., actuation system).

The gear reduction mechanism 60 transfers torque from the input shaft 12 to the primary output shaft selectively in one of two drive ratios at a given time. The gear reduction mechanism 60 may, for example, be configured as a planetary gear set 62 with a fixed ring gear and with the input shaft 12 acting as a sun gear. A shift sleeve 64 (e.g., sleeve, locking sleeve, or dog clutch) is rotatably fixed to the primary output shaft 120 but is movable axially thereon (e.g., via a sliding splined connection) with the actuator 80. In a first position (e.g., forward position, depicted in phantom (i.e., dashed lines) in FIG. 2), the shift sleeve 64 rotatably couples to the input shaft 12 (e.g., via a selective splined connection), so as to rotatably couple the input shaft 12 to the primary output shaft 20 with a 1:1 drive ratio (e.g., high range). In a second position (e.g., rearward position, shown in solid lines in FIG. 2), the shift sleeve 64 rotatably couples to a planet carrier of the planetary gear set 62, so as to rotatably couple the input shaft 12, which acts as the sun gear, to the primary output shaft 20 with a reduced gear ratio (e.g., a low range). Alternatively, the transfer case 10 may be a single-speed transfer that does not include a gear reduction mechanism.

The secondary torque transfer mechanism 70 selectively transfers torque from the primary output shaft 20 to the secondary output shaft 30. The secondary torque transfer mechanism 70 generally includes a plate clutch 72, a primary sprocket 74, a secondary sprocket 76, and a chain 78. The plate clutch 72 selectively rotatably couples the primary sprocket 74 to the primary output shaft 20. The secondary sprocket 76 is rotatably fixed to the secondary output shaft 30. The chain 78 extends between the primary sprocket 74 and the secondary sprocket 76 and transfers torque therebetween. The chain 78, thereby, transfers torque between the primary output shaft 20 and the secondary output shaft 30 when the plate clutch 72 is operated (e.g., compressed). The plate clutch 72 may be operated by the actuator 80 or another actuator system. Alternatively, the secondary torque transfer mechanism 70 may transfer torque between the primary output shaft 20 and the secondary output shaft 30 with gears (i.e., replacing the primary sprocket 74, the secondary sprocket 76, and the chain 78).

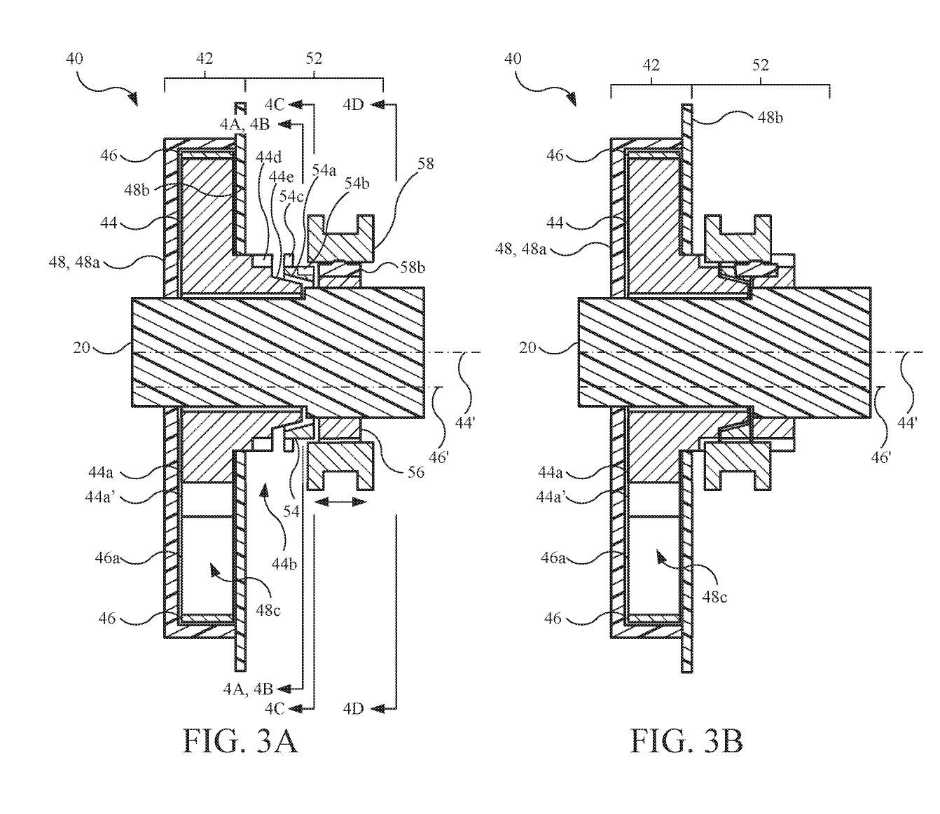

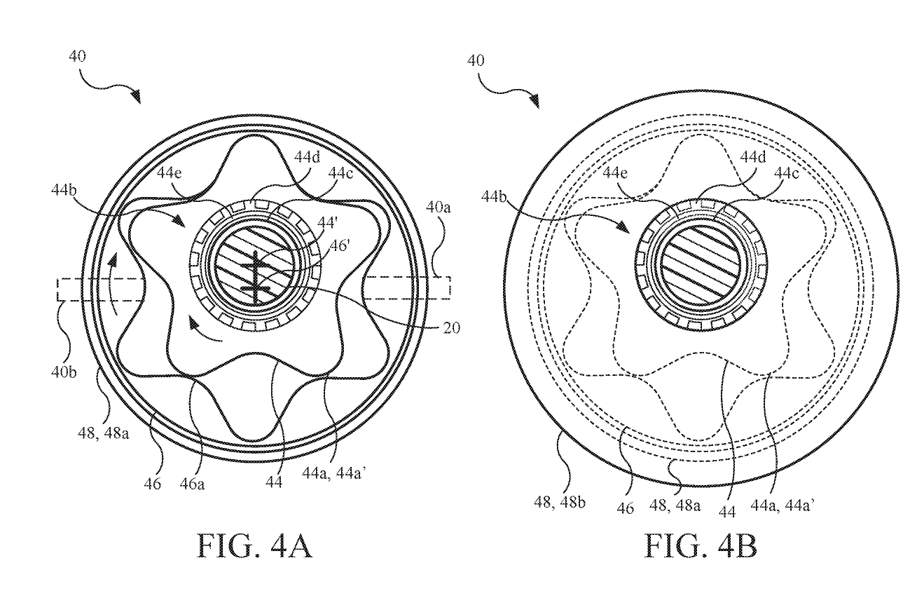

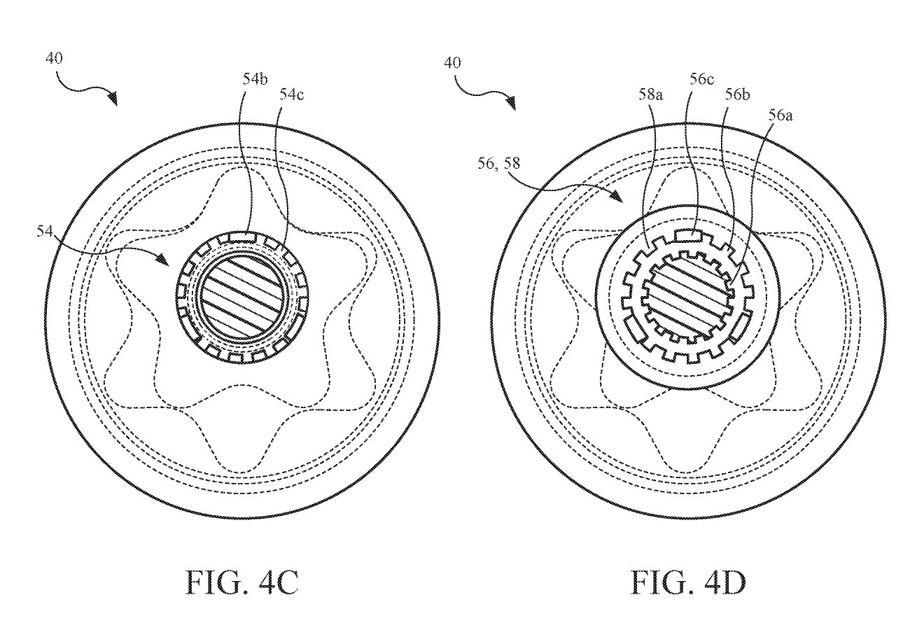

Referring additionally to FIGS. 3A-4D, the pump 40 is selectively drivable by the primary output shaft 20. The pump 40 generally includes a pumping portion 42 and an actuation portion 52. The pumping portion 42 is configured to pump the fluid and is, for example, configured as a gerotor pump. The actuation portion 52 interacts with the actuator 80 to selectively operationally couple the pumping portion 42 to the primary output shaft 20. The actuation portion 52, or subportions and/or components thereof, may instead or additionally be considered part of the actuator 80.

The pumping portion 42 is configured as a gerotor pump and generally includes a rotor portion 44a of an inner rotor 44 (e.g., a rotary component, or inner or driving component), an outer rotor 46 (e.g., outer or driven component), and a pump housing 48 (e.g., a stationary component). The inner rotor 44 includes the rotor portion 44a and a coupling portion 44b extending axially therefrom. The rotor portion 44a is surrounded by the outer rotor 46 and includes teeth 44a′ (e.g., lobes) on an outer periphery thereof, which number one fewer than inner teeth 46a (e.g., lobes) on an inner periphery of the outer rotor 46. As the rotor portion 44a of the inner rotor 44 is rotated relative to the pump housing 48 about a first axis 44′ (e.g., inner rotor axis), which the primary output shaft 20 also rotates about, the outer rotor 46 is engaged and rotated by the rotor portion 44a relative to the pump housing 48. The outer rotor 46 rotates at a slower speed than the inner rotor 44 about a second axis 46′ offset from the first axis 44′. As a result, a low pressure region and a high pressure region are generated between the rotor portion 44a and the outer rotor 46 which are in fluidic communication, respectively, with an inlet 40a and an outlet 40b (see FIG. 4A) to pump the fluid through the pump 40 (i.e., through the pumping portion 42 thereof). The pumping portion 42 may be configured as another type of suitable pumps (e.g., a rotary vane pump having a rotor that functions as a rotary member by rotating relative to the fixed housing with vanes that move radially inward and outward).

As referenced above, the pump 40 is driven by the primary output shaft 20. The pump housing 48 surrounds the primary output shaft 20 and is fixed (e.g., stationary) relative to the transfer case housing 14. The primary output shaft 20 passes through the pump housing 48. The pump housing 48 encloses (e.g., seals) the rotor portion 44a of the inner rotor 44 and the outer rotor 46 therein, which themselves also surround the primary output shaft 20. When the primary output shaft 20 is operatively coupled to the inner rotor 44, the rotor portion 44a thereof and, thereby, the outer rotor 46 are rotated by the primary output shaft 20 relative to the pump housing 48.

The pump housing 48 generally includes a first housing member 48a (e.g., case or structure) and a second housing member 48b (e.g., cover, plate, or structure), which cooperatively define a chamber 48c and enclose (e.g., seal) the rotor portion 44a of the inner rotor 44 and the outer rotor 46 therein. The chamber 48c is substantially cylindrical and complementary to the outer rotor 46 for rotation therein (e.g., sharing the second axis 46′ and having a slightly larger diameter). The first housing member 48a includes a first through hole (not labeled) through which the primary output shaft 20 passes. The second housing member 48b includes a second through hole (not labeled) through which the primary output shaft 20 and the coupling portion 44b of the inner rotor 44 (described in further detail below) extends.

The actuator portion 52 of the pump 40 is configured to selectively rotatably couple the inner rotor 44 to the primary output shaft 20, such that the inner rotor 44 is rotated by the primary output shaft 20 to operate (e.g., drive) the pump 40. More particularly, the actuator portion 52 of the pump 40 frictionally and mechanically couples the inner rotor 44 to the primary output shaft 20 for operation of the pump 40. As the pump 40 is activated (e.g., begins to operate), the friction coupling is first formed (e.g., via a cone clutch) and the mechanical coupling is subsequently formed (e.g. via a dog clutch). The actuator portion 52 of the pump 40 may be considered to include the coupling portion 44b (e.g., second or exterior portion) of the inner rotor 44, and also includes a friction ring 54 (e.g., blocker ring or friction member), an inner hub 56 (e.g., synchronizer hub), and an outer sleeve 58 (e.g., shift sleeve).

Referring to FIGS. 3A-4B, the coupling portion 44b (e.g., exterior portion) of the inner rotor 44 is an annular structure that extends axially from the rotor portion 44a of the inner rotor 44. FIG. 4A is a partial cross-sectional view in which the second housing member 48b and the friction ring 54 are omitted; FIG. 4B is a partial cross-sectional view in which the friction ring 54 is omitted and various hidden components are depicted in dashed lines. The coupling portion 44b protrudes axially from the pump housing 48, for example, though the aperture of the second housing member 48b. The coupling portion 44b may, for example, be formed integrally with the interior portion (e.g., via a casting or powdered metal process), or may be formed separately and fixedly coupled thereto. The primary output shaft 20 extends through a through hole 44c of the inner rotor 44 through both the coupling portion 44b and the rotor portion 44a. The through hole 44c is concentric with the first axis 44′ and allows the primary output shaft 20 to rotate therein freely of the inner rotor 44.

The coupling portion 44b of the inner rotor 44 is configured to be engaged by various other components of the actuator portion 52 of the pump 40 to form the friction coupling and the mechanical coupling between the inner rotor 44 and the primary output shaft 20. Moving axially away from the pump housing 48, the coupling portion 44b includes a splined region and a tapered region. The splined region includes outer splines 44d (e.g., teeth) that protrude radially outward relative to an outer periphery 44e (e.g., tapered outer surface) of the tapered end. The outer periphery 44e of the tapered end reduces in diameter moving away from the pump housing 48 to form a male cone component of the cone clutch.

The friction ring 54, the inner hub 56, and the outer sleeve 58 are cooperatively configured with the coupling portion 44b of the inner rotor 44 to form the friction coupling and the mechanical coupling between the inner rotor 44 and the primary output shaft 20. More particularly, the friction ring 54 is configured to receive the outer periphery 44e of the coupling portion 44b of the inner rotor 44 to form the friction coupling. The outer sleeve 58 is configured to engage the outer splines 44d of the coupling portion 44b of the inner rotor 44 to form the mechanical coupling.

Referring to FIGS. 3A, 3B, and 4C, the friction ring 54 is configured frictionally couple to the coupling portion 44b of the inner rotor 44 and mechanically couple to the outer sleeve 58. FIG. 4C is a partial cross-sectional view in which the outer sleeve 58 and the inner hub 56 are omitted and various hidden components or features are depicted in dashed lines. The friction ring 54 has an inner periphery 54a (e.g., tapered inner surface) that is configured to receive and press against outer periphery 44e of the coupling portion 44b of the inner rotor 44 to form a frictional coupling therebetween (e.g., forming a cone clutch). The inner periphery 54a is shaped in a complementary manner to the outer periphery 44e of the coupling portion 44b for receipt thereof (e.g., being conical) and to form the friction coupling (e.g., having an appropriate friction material and/or texture). The primary output shaft 20 extends the friction ring 54 and is able to rotate freely thereof.

The friction ring 54 additionally includes key slots 54b in an outer periphery thereof, which are configured to receive key members 58b (e.g., struts) of the outer sleeve 58 in an axial direction. The key members 58b may both bias the friction ring 54 toward the coupling portion 44b to for receipt within and engagement by the inner periphery 54a, and also mechanically couple the friction ring 54 to the outer sleeve 58 (discussed further below). The friction ring 54 additionally includes outer splines 54c (e.g., teeth), which are sized and spaced in a complementary manner (e.g., similar or same circumferential size and spacing) to the outer splines 44d of the coupling portion 44b of the inner rotor 44, which allows receipt of the outer sleeve 58 thereover.

Referring to FIGS. 3A, 3B, and 4D, the inner hub 56 is an annular member that rotatably fixes the primary output shaft 20 to the outer sleeve 58 via splined connections (e.g., having inner splines 56a and outer splines 56b). FIG. 4D is a partial cross-sectional view in which various hidden components or features are depicted in dashed lines. The primary output shaft 20 extends through each of the inner hub 56 and the outer sleeve 58. The inner hub 56 additionally includes axially-extending slots 56c in which the key members 58b are fixed circumferentially and slide axially when moved by the outer sleeve 58.

The outer sleeve 58 is rotatably fixed to the primary output shaft 20 via the inner hub 56 and selectively rotatably couples to the coupling portion 44b of the inner rotor 44 and to the friction ring 54. The outer sleeve 58 includes inner splines 58a that protrude radially inward. The inner splines 58a are configured in a complementary manner to the outer splines 44d of the coupling portion 44b of the inner rotor 44 and to the outer splines 54c of the friction ring 54 to allow receipt of the inner splines 58a therebetween as the outer sleeve 58 is moved axially.

The outer sleeve 58 is movable between a first position (shown in FIG. 3A) and a second position (shown in FIG. 3B) in which the pump 40 is and is not, respectively, operational. As the outer sleeve 58 is moved from the first position to the second position (e.g., in a forward direction as shown), the outer sleeve 58 becomes mechanically coupled to the friction ring 54. The key members 58b initially move axially with the outer sleeve 58 and into the key slots 54b of the friction ring 54, such that the friction ring 54 becomes rotatably coupled to the outer sleeve 58.

With continued axial movement, the outer sleeve 58 causes the friction ring 54 to frictionally couple to the coupling portion of the inner rotor 44. The outer sleeve 58 presses the key members 58b axially against the friction ring 54, which in turn causes the friction ring 54 to move forward and engage the outer periphery 44e of the coupling portion 44b. The coupling portion 44b of the inner rotor 44 and the friction ring 54 thereby become frictionally coupled. With the friction ring 54 being rotatably coupled to the outer sleeve 58 (i.e., via the key members 58b) and the outer sleeve 58 also being rotatably fixed to the primary output shaft 20 (i.e., via the inner hub 56), this friction coupling causes torque to be transferred from the primary output shaft 20 to the inner rotor 44 to cause rotation thereof. That is, the outer sleeve 58 is frictionally coupled to the inner rotor 44 via the friction ring 54, and the primary output shaft 20 is frictionally coupled to the inner rotor via the friction ring 54 and the outer sleeve 58.

After the inner rotor 44 is brought to the same rotational speed as the primary output shaft 20, the outer sleeve 58 is moved further toward the coupling portion 44b of the inner rotor 44. The inner splines 58a of the outer sleeve 58 and the outer splines 54c of the friction ring 54 are received between each other, while the key members 58b remain in their axial position biased against the friction ring 54 to maintain the friction coupling. The inner splines 58a of the outer sleeve 58 and the outer splines 54c of the friction ring 54 may include tapered leads to facilitate receipt of each other therebetween.

The outer sleeve 58 is then moved still further toward the coupling portion 44b of the inner rotor 44, such that the inner splines 58a of the outer sleeve 58 and the outer splines 44d of the coupling portion 44b of the inner rotor 44 are received between each other to mechanically couple the outer sleeve 58 to the inner rotor 44. The key members 58b remain in their axial position biased against the friction ring 54 (i.e., do not continue to move with the outer sleeve 58). With the outer sleeve 58 remaining rotatably fixed to the primary output shaft 20 (i.e., via the inner hub 56), this mechanical coupling between the inner rotor 44 and the outer sleeve 58 mechanically couples the inner rotor 44 to the primary output shaft 20 to rotate therewith for operation of the pump 40.

To stop operating the pump 40, the outer sleeve 58 is moved from the second position to the first position. The inner splines 58a are removed from between the outer splines 44d of the inner rotor 44 to remove the mechanical coupling between the inner rotor 44 and the primary output shaft 20. With continued axial movement, the inner splines 58a of the outer sleeve are then removed from between the outers splines 54c of the friction ring 54. The key members 58b lessen pressure on the friction ring 54 to remove the friction coupling between the friction ring 54 and the coupling portion 44b of the inner rotor 44 and, thereby, between the inner rotor 44 and the primary output shaft 20. As a result, the primary output shaft 20 may then rotate independent of the inner rotor 44, such that the pump 40 no longer operates.

Referring again to FIG. 2, the actuator 80 moves the outer sleeve 58 to selectively rotatably couple the inner rotor 44 to the primary output shaft 20 to operate the pump 40. The actuator 80 generally includes a cam mechanism 82, a fork 84 (e.g., shift fork or fork member), and a motor 86.

The fork 84 is rotationally fixed within the transfer case housing 14 and movable axially therein. The fork 84 is additionally axially fixed to the outer sleeve 58, while allowing the outer sleeve 58 to rotate relative thereto, for example, by being received in a circumferential slot 58c of the outer sleeve 58. As the fork 84 is moved axially, the outer sleeve 58 moves axially therewith between the first position and the second positon.

The cam mechanism 82 engages the fork 84 to move the fork 84 and, thereby, the outer sleeve 58 between the first position and the second position. The cam mechanism 82, for example, includes a cam member 82a (e.g., first or pump cam member) that is coupled to and rotated by a shaft 82b. The cam member 82a, for example, includes a cam slot 82a′ (e.g., first or pump cam slot or track) in which a portion of the fork 84 is received. The cam slot 82a′ is defined between ramped surfaces (i.e., that have an axial component) of the cam member 82a. With the fork 84 being fixed rotationally within the transfer case housing 14, rotation of the cam member 82a (i.e., by the motor 86 via the shaft 82b) in both rotational directions causes the fork 84 to be moved axially relative to the transfer case housing 14 within the cam slot 82a′. The outer sleeve 58 is thereby moved axially between the first position and the second position (i.e., for coupling the inner rotor 44 to the primary output shaft 20).

The actuator 80 may additionally be configured to operate the gear reduction mechanism 60. The actuator 80 includes another shift fork 88, while the cam mechanism 82 includes another cam member 82c (e.g., second or gear cam member) coupled to the shaft 82b. The shift fork 88 is also rotationally fixed and axially movable within the transfer case housing 14. The shift fork 88 is axially fixed to the shift sleeve 64, while allowing the shift sleeve 64 to rotate relative thereto (e.g., being rotationally coupled to the primary output shaft 20) by being received in a circumferential slot (not labeled) of the shift sleeve 64. The cam member 82c includes another cam slot 82c′ (e.g., second or gear cam slot) in which a portion of the shift fork 88 is received. The cam slot 82c′ is defined between ramped surfaces (i.e., that have an axial component) of the cam member 82c, such that as the shaft 82b is rotated selectively by the motor 86 in both rotational directions, the shift fork 88 is moved axially relative to the transfer case housing 14 within the cam slot 82c′. The shift sleeve 64 is thereby moved between the first position (shown in FIG. 2 for high range) and the second position (shown in phantom (i.e., dashed lines) in FIG. 2 for low range).

The actuator 80 may be configured to operate the pump 40 and the gear reduction mechanism 60 in different stages of rotation of the motor 86 and/or the cam mechanism 82. That is, when the motor 86 is rotated, the pump 40 and the gear reduction mechanism 60 are operated asynchronously. For example, in a central range of rotation of the cam mechanism 82, the shift sleeve 64 may be moved axially between the first position and the second position to select the different drive ratios, while the outer sleeve 58 of the pump 40 is held axially in the first position to not operate the pump 40. Corresponding to this central range of rotation, the cam slot 82a′ is not ramped (e.g., is flat or otherwise has no axial component) to maintain the first position of the outer sleeve 58, while the cam slot 82c′ is ramped to move the shift sleeve 64 between the first position and the second position thereof. In outer ranges of rotation (e.g., continuing from ends of the central range of rotation), the shift sleeve 64 is instead held axially in the first position or the second position thereof, while the outer sleeve 58 of the pump 40 is moved axially between the first position and the second position thereof. Corresponding to these outer ranges of rotation, the cam slot 82a′ is ramped to move the outer sleeve 58, while the cam slot 82c′ is flat to maintain the first position or the second position of the outer sleeve 58. In this manner, the pump 40 may be operated by the motor 86 when the gear reduction mechanism 60 is in the high or low range. The pump 40 may not be operational when the gear reduction mechanism 60 is changing between the high and low range during which fluid flow may not be needed (e.g., for lubricating and/or cooling components of the transfer case 10), since the vehicle 1 may be stopped.

In still further embodiments, the actuator 80 may be configured to operate another mechanism of the transfer case 10 instead of, or in addition to, operating the gear reduction mechanism 60. For example, the actuator 80 may include another cam member and shift fork that operate to compress the plate clutch 72 directly or with an intermediate mechanism.

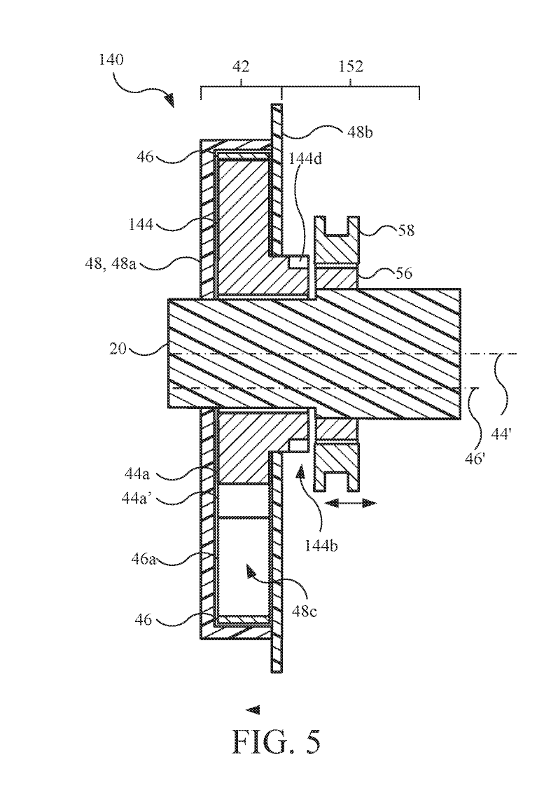

Variations of the pump 40 are contemplated. For example, as shown in FIG. 5, a pump 140 may instead be used in the transfer case 10. The pump 140 includes the pumping portion 42 (described previously) and an actuation portion 152. The actuation portion 152 is configured to form a mechanical coupling between the pumping portion 42 of the pump 140 and the primary output shaft 20. In this variation, the friction ring 54 is omitted, along with the outer periphery 44e (e.g., conical portion) of the inner rotor 44, and the key members 58b. The pump 140 includes an inner rotor 144 having a rotor portion 44a (configured as describe previously) and a coupling portion 144b that includes outer splines 144d. The outer sleeve 58 is movable axially with the inner splines (not shown; refer to inner splines 58a) being received between the outer splines 144d of the inner rotor 144. To facilitate engagement, the inner splines of the outer sleeve 58 and the outer splines 144d of the inner rotor may include axial end profiles that allow for gradual engagement between the outer sleeve 58 and the inner rotor 144 and/or lessen clash that might otherwise occur therebetween as the inner rotor 144 comes up to rotational speed with the primary output shaft 20. For example, the ends of the outer splines 144d and/or those of the outer sleeve 58 may taper on one or both sides thereof.

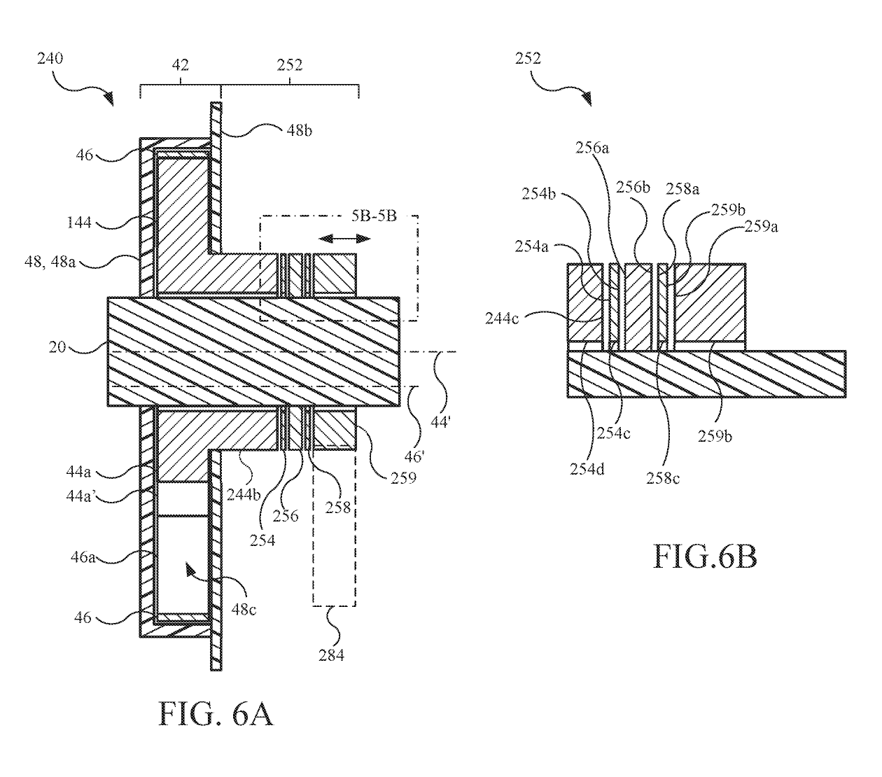

Referring to FIGS. 6A-6B, a pump 240 may instead be used in the transfer case 10. The pump 240 includes the pumping portion 42 (described previously) and an actuation portion 252. The actuation portion 252 is configured to form a friction coupling between the pumping portion 42 (i.e., the inner rotor 144) of the pump 240 and the primary output shaft 20.

The pump 40 includes an inner rotor 244 that itself includes the rotor portion 44a described previously (i.e., having the first axis 44′ and including teeth 44a′) and a coupling portion 244b that may be formed integrally with the rotor portion 44a. The actuation portion 252 of the pump 240 may be considered to include the coupling portion 244b of the inner rotor 244, and additionally includes a friction plate 254 (e.g., friction member), a pressure plate 256, a thrust bearing 258, and an apply plate 259. Broadly speaking, the apply plate 259 is moved axially by the actuator 80 toward the inner rotor 244, whereby the friction plate 254 is compressed between the coupling portion 244b of the inner rotor 244 and the apply plate 259 to frictionally couple the inner rotor 244 to the primary output shaft 20.

The coupling portion 244b of the inner rotor 244 protrudes from the pump housing 48 to form a coupling surface 244c, which is an axial facing surface configured to frictionally couple to the friction plate 254. The inner rotor 244 additionally includes a through hole 244d, which extends through both the rotor portion 44a and the coupling portion 244b, and through which the primary output shaft 20 extends and is able to rotate freely thereof.

The friction plate 254 (e.g., friction disk) is an annular member formed of or coated with suitable material for forming the friction coupling with the coupling surface 244c of the inner rotor 244 and additionally with the pressure plate 256. The friction plate 254 forms a first friction surface 254a, which is an axial facing surface sized and shaped in a complementary manner to the coupling surface 244c of the inner rotor 244 for forming a friction coupling therewith. For example, the coupling surface 244c and the first friction surface 254a may both be planar and have a common diameter. The friction plate 254 additionally forms a second friction surface 254b, which is another axial facing surface directed opposite the first friction surface 254a for forming another friction coupling with the pressure plate 256. The friction plate 254 additionally includes a through hole 254c through which the primary output shaft 20 extends and is able to rotate freely thereof.

The pressure plate 256 is an annular member, which is rotationally fixed to the primary output shaft 20 and is axially movable thereon (e.g., via a sliding splined connection). The pressure plate 256 includes a first pressure surface 256a, which is an axially facing surface sized and shaped in a complementary manner to the second friction surface 254b of the friction plate 254 for forming a friction coupling therewith. For example, the second friction surface 254b and the first pressure surface 256a may be planar and have a common diameter, which may be the same as the diameter of the coupling surface 244c of the inner rotor 244 and the first friction surface 254a. The pressure plate 256 also includes a second pressure surface 256b, which is an axially facing surface directed opposite the first pressure surface 256a and facing toward the thrust bearing 258. The pressure plate 256 additionally includes inner splines (not labeled) that form the sliding splined connection with complementary splines (not labeled) of the primary output shaft 20.

The thrust bearing 258 is arranged axially between the pressure plate 256 and the apply plate 259 to reduce friction therebetween (e.g., as the pressure plate 256 is rotated by the primary output shaft 20). The thrust bearing 258 may, for example, include needles or other rollers (not shown) that engage the second pressure surface 256b of the pressure plate 256, which rotates with the primary output shaft 20, and/or the apply plate 259, which does not rotate. The thrust bearing 258 additionally includes a through hole 258c through which the primary output shaft 20 extends and is able to rotate freely thereof.

The apply plate 259 is engaged and movable by the actuator 80 to apply axial pressure that compresses the friction plate 254 between the inner rotor 244 and the pressure plate 256 to form a friction coupling therebetween and, ultimately, between the inner rotor 244 and the primary output shaft 20. The apply plate 259 includes a first apply surface 259a, which is an axial surface that engages the thrust bearing. The apply plate 250 additionally includes a through hole 259b through which the primary output shaft 20 extends and is able to rotate freely thereof.

The apply plate 259 is fixed to a shift member 284, so as to move axially therewith and to not rotate. The shift member 284 replaces the fork 84 in the actuator 80.

To operate the pump 240, the apply plate 259 is biased by the actuator 80 toward the inner rotor 244, so to apply axial force through the thrust bearing 258, the pressure plate 256, and the friction plate 254 to the inner rotor 244. The actuator 80 is configured similarly for use with the pump 240 with the fork 84 instead being coupled to the apply plate 259 as referenced above. Application of this axial force by the apply plate 259, thereby, compresses the friction plate 254 between the coupling surface 244c of the coupling portion 244b of the inner rotor 244 and the first pressure surface 256a of the pressure plate 256 to form friction couplings therebetween. With the pressure plate 256 additionally being rotatably fixed to the primary output shaft 20, these friction couplings frictionally couple the inner rotor 244 to the primary output shaft 20 to transfer torque therebetween for operating the pump 240. To stop operation of the pump 240, the apply plate 259 and, thereby, the apply plate 259 is moved away from the inner rotor 244.

The actuation portion 252 of the pump 240 may be configured in various other manners for forming a friction coupling between the inner rotor 244 and the primary output shaft 20. For example, the friction plate 254 may be omitted with the coupling surface 244c of the inner rotor 244 and/or the first pressure surface 256a of the pressure plate 256 instead including appropriate friction material for forming the friction coupling directly therebetween. Instead, or additionally, the thrust bearing 258 may be omitted with the second pressure surface 256b of the pressure plate 256 and/or the first apply surface 259a of the apply plate 259 instead being configured as a suitable bearing surface for decreasing friction therebetween that might occur with relative rotation.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A torque transfer device for a powertrain of a vehicle comprising:
a shaft for transferring torque from a drive source to a wheel of the vehicle;
a pump comprising a rotary component and a housing that surrounds the shaft, wherein the rotary component is selectively rotatably coupleable to the shaft to be rotated thereby to operate the pump; and
an actuator comprising a cam mechanism that selectively moves the annular member to rotatably couple the rotary component to the shaft.

2. The torque transfer device according to claim 1, wherein the pump is selectively coupleable to the shaft with at least one of a friction coupling or a mechanical coupling.

3. The torque transfer device according to claim 2, wherein the pump is selectively coupleable to the shaft with a friction coupling.

4. The torque transfer device according to claim 3, wherein the pump is selectively coupleable to the shaft with a mechanical coupling.

5. The torque transfer device according to claim 1, wherein the cam mechanism includes a motor and a cam member that is rotated by the motor for coupling the rotary component to the shaft.

6. The torque transfer device according to claim 5, further comprising at least one of a gear reduction mechanism or a secondary torque transfer mechanism, wherein the cam mechanism includes another cam member that is rotated by the motor for operating the gear reduction mechanism or the secondary torque transfer mechanism.

7. The torque transfer device according to claim 6, further comprising the gear reduction mechanism, and wherein the other cam member is rotated by the motor for operating the gear reduction mechanism.

8. The torque transfer device according to claim 6, wherein when the motor is rotated, the pump and the gear reduction mechanism are operated asynchronously.

9. The torque transfer device according to claim 1, wherein the rotary component includes a coupling portion that protrudes axially from the housing and that surrounds the shaft, and the coupling portion is selectively coupleable to an annular member of the pump rotatably fixed to and axially movable relative to the shaft.

10. The torque transfer device according to claim 9, wherein the annular member is an outer sleeve selectively rotatably coupleable to the annular member with a friction coupling and with a mechanical coupling.

11. The torque transfer device according to claim 10, wherein the pump includes a friction ring having a tapered inner surface that receives a tapered outer surface of the coupling portion to form the friction coupling when the friction ring is moved axially by the annular member toward the coupling portion.

12. The torque transfer device according to claim 11, wherein the outer sleeve includes inner splines that receive outer splines of the coupling portion to form the mechanical coupling when the annular member is moved axially toward the coupling portion.

13. The torque transfer device according to claim 9, wherein the annular member is a pressure plate selectively rotatably coupleable to the annular member with a friction coupling.

14. The torque transfer device according to claim 13, wherein the pump includes a friction plate that is compressed between the coupling portion and the pressure plate to form the friction coupling.

15. The torque transfer device according to claim 14, wherein the pump further includes an apply plate and a thrust bearing axially between the pressure plate and the apply plate, and the apply plate is rotatably fixed and axially movable by the actuator.

16. The torque transfer device according to claim 1, wherein the cam mechanism includes a motor and a cam member that is rotated by the motor for coupling the rotary component to the shaft with a friction coupling; and
wherein the rotary component includes a coupling portion that protrudes axially from the housing and that surrounds the shaft, the coupling portion is selectively coupleable to an annular member of the pump to form the friction coupling, the annular member being rotatably fixed to and axially movable relative to the shaft by the cam mechanism.

17. A pump comprising:
a pumping portion comprising:
a housing, and a rotary component rotatable within the housing for pumping a fluid; and
actuator portion comprising:
a coupling portion formed integrally with the rotary component and extending axially from the housing, and
an annular member movable axially toward the coupling portion to couple the rotary component to a drive shaft for operating the pump;
wherein the housing, the rotary component, the coupling portion, and the annular member are each configured for the drive shaft to extend therethrough, and the annular member is configured to be rotatably fixed to and axially movable relative to the drive shaft.

18. The pump according to claim 17, further comprising an actuator having a motor and a cam mechanism that, when rotated by the motor, is configured to move the annular member axially to couple the rotary component to the drive shaft.

19. The pump according to claim 18, further comprising a friction member arranged axially between the coupling portion and the annular member and configured for the drive shaft to extend therethrough, wherein when the annular member is moved by the actuator axially toward the coupling portion, the friction member is compressed between the coupling portion and the annular member to rotatably couple the rotary component to the annular member.

20. A transfer case comprising:
a primary output shaft; and
a pump that surrounds and is selectively operatively coupleable to the primary output shaft for operating the pump, the pump comprising:
a housing;
a rotary component partially enclosed within and protruding from the housing to form a coupling portion, the rotary component being rotatable within the housing to pump a fluid through the pump;
an annular member rotatably fixed to and axially movable relative to the primary output shaft; and
an actuator that moves the annular member axially toward the coupling portion to operatively couple the coupling portion of the rotary component to the primary output shaft.
